(19) United States
(12) Patent Application Publication
(10) Pub. No.: US 2021/0024210 A1
(43) Pub. Date: Jan. 28, 2021

(54) DRONE FOR LOW-NOISE DELIVERY OF OBJECTS

(71) Applicant: DELIVERY EAGLE AG, Ruggell (LI)

(72) Inventor: Herbert Weirather, Ruggell (LI)

(21) Appl. No.: 16/938,346

(22) Filed: Jul. 24, 2020

(30) Foreign Application Priority Data
Jul. 25, 2019 (EP) 19188376.8

(51) Int. Cl. B64C 39/02

(52) U.S. Cl. CPC B64C 39/024; B64C 2201/021; B64C 2201/084; B64C 2201/182; B64C 2201/128; B64C 2201/141; B64C 2201/162; B64C 2201/104

(57) ABSTRACT

The present invention relates to a fixed wing drone for delivering objects, a takeoff and landing device for a fixed wing drone, a system made up of a drone and a takeoff and landing device, and an approach method for said system. The fixed wing drone comprises wing control surfaces, at least two drive units, at least one tail assembly, at least one structure element which protrudes to the rear and is accessible from the rear, an object holding device, a receiving unit, and a control unit. The takeoff and landing device permits a fixed wing drone to land silently on a vertical structure.

### CROSS REFERENCE TO RELATED APPLICATIONS

This application claims the benefit of European Patent Application No. EP19188376.8 filed on Jul. 25, 2019. The contents of the application are hereby incorporated by reference in its entirety.

### FIELD OF THE INVENTION

The present invention relates to a drone for delivering objects, a takeoff and landing device for a drone designed as a fixed wing aircraft, a system made up of a drone and a takeoff and landing device, and an approach method for said system.

### BACKGROUND OF THE INVENTION

Drones for delivering packages are known from the prior art. The significant advantages for package delivery using drones are obvious. Firstly, they are extremely fast. Drones can fly the direct route, do not always have to decelerate and accelerate, do not wait in traffic jams, and are very energy efficient. All drone concepts are very environmentally friendly in comparison to automobile delivery, since they fly electrically, do not emit CO2, soot particles, or toxic gases, do not have rubber abrasion, and above all environmentally harmful roads are not used and/or are even relieved. Drones not only drastically reduce the delivery time, but rather furthermore also minimize the costs on the part of the delivering companies, since fewer personnel are required.

Multicopter drones can be positioned in space in a defined manner nearly without restrictions. However, they generate a large amount of noise in flight, which comes to bear in particular during takeoff, landing, and when hovering. A nighttime delivery is thus precluded from the outset. Package delivery multi-copters are known, which lower a package at the receiver via cable while they are located above the delivery point. However, this solution has security risks, because dogs could attack the package being lowered and/or seize the cable and cause the drone to crash.

In addition to multi-copter drones, there are also the so-called fixed wing aircraft—i.e., planar models or flying wings. The advantage of the classical aircraft shape is the range, because almost no energy is used for the lift in the aircraft, in contrast to the multi-copter, which has to generate the lift permanently via the rotors. The disadvantage is that a fixed wing aircraft is not as maneuverable as a multi-copter, i.e., it cannot fly arbitrarily slow, remain stationary in the air, or even fly in reverse. There are fixed wing drones for delivering packages, wherein the package can be ejected with a small parachute at the height of a landing zone.

In the mentioned examples, exclusively open areas, gardens, or flat roofs are suitable as delivery locations, wherein only very few persons have such delivery locations. Persons living in the city can only receive deliveries if the roof is also accessible. In addition, third parties can relatively easily obtain access to the package which has been ejected or lowered by cable.

Known solutions moreover require a large amount of space for daily storage of the drones, for example, to charge their batteries or carry out maintenance work. The noise emission is probably the most problematic factor for society due to the increasing drone traffic in the air.

### OBJECT OF THE INVENTION

The invention therefore achieves the object of delivering an object to a receiver without causing annoying noise emissions at the same time.

### SUMMARY OF THE INVENTION

The invention relates to a fixed wing drone for delivering objects, comprising a wing having an airfoil and having wing control surfaces, having at least two drive units, at least one tail assembly having tail control surfaces, wherein the tail assembly is arranged above the wing and behind the wing by a carrier element connected to the wing, at least one structure element protruding towards the rear and accessible from the rear, an object holding device, which is arranged above the wing and is designed to accommodate an object, a control unit, which is designed to control the fixed wing drone, in particular the wing control surfaces, the tail control surfaces, and the drive units, based on control signals, and a receiving unit, which is designed to receive control signals.

The drive units can comprise enclosed propellers, in particular impellers.

Each of the engagement elements can be designed as a sliding element or a rotatably mounted disk.

The object holding device can comprise a conveyer system, which is designed to convey an object accommodated by the object holding device to the front or rear, in particular to convey the object in front of or behind the wing and to eject it in front of or behind the wing or to change the center of gravity during a flight.

The fixed wing drone can furthermore comprise a camera system which is designed for object recognition, wherein the control unit for controlling the fixed wing drone is furthermore designed based on the object recognition.

The invention furthermore relates to a takeoff and landing device, which comprises the following: (a) an attachment device, which is designed to attach the takeoff and landing device to a structure, in particular to a vertical side of a structure, (b), a guide element, which is connected to the attachment device and is configured so that, starting from the attachment device, it leads away from the structure downward and at an angle between 1° and 89°, in particular 12° in relation to the vertical, and (c), a holding element, which is attached transversely to, in particular horizontally on the guide elements and comprises at least one counter structure element accessible from above.

The takeoff and landing device can furthermore comprise at least one takeoff guide element, which is connected to the attachment device and leads upward and away from the structure, starting from the attachment device, at an angle between 1° and 89° in relation to the vertical.

The takeoff and landing device can furthermore comprise an object catching device, in particular where the attachment device comprises the object catching device.

The takeoff and landing device can furthermore comprise a fixing device, in particular comprising an electromagnet designed to provide an attraction force for attracting the fixed wing drone or comprising a mechanical fixing mechanism.

The invention also relates to a system comprising a fixed wing drone and a takeoff and landing device according to the description herein.

The structure element of the fixed wing drone and the counter structure element are preferably designed to be interlockable in this case, and the fixed wing drone is preferably displaceable along the holding element by means of the interlocking structure element and counter structure element.

The takeoff guide element can be designed as a clamping device, which is pivotable between an open state and a closed state, wherein the clamping device leads upward and away from the structure in the open state, starting from the attachment device, at an angle between 1° and 89° in relation to the vertical and in the closed state can be abutted up to the holding element or to the guide element, wherein the clamping device is motorized or can be moved into the open state under pre-tension and, triggered by a landing fixed wing drone, provides a clamping mechanism, wherein the clamping device is designed to clamp the landed fixed wing drone, in particular on the wing.

The takeoff and landing device can comprise a light guiding system, which comprises at least one lighting element or a reflector, wherein the camera system is designed to recognize the lighting element or the reflector, wherein the control unit is designed to determine a pose of the takeoff and landing device with the aid of the recognized lighting element or reflector and to generate control signals with the aid of the determined pose.

The fixed wing drone can furthermore comprise an interface, which is designed to receive electrical energy and/or data, wherein the takeoff and landing device comprises a corresponding counter interface, which is designed to supply a fixed wing drone with electrical energy and/or data.

The invention also relates to an approach method for a system according to the description. The approach method comprises at least the following steps:

loading a fixed wing drone with an object,

controlling the fixed wing drone based on received control signals in the direction of a delivery location until a defined remaining distance remains to the delivery location,

after reaching the remaining distance, deactivating the drive units,

activating a light guiding system of a takeoff and landing device, which is attached to a structure,

recognizing the lighting element or the reflector using the camera system,

with the aid of the recognized lighting element or reflector, determining a pose of the takeoff and landing device using the control unit,

with the aid of the determined pose, generating control signals using the control unit,

controlling only the wing control surfaces and the tail control surfaces of the fixed wing drone, which is in glide flight, based on the generated control signals,

carrying out a landing approach which causes the fixed wing drone to temporarily sink below the takeoff and landing device and then rise again in a parabola to the takeoff and landing device,

achieving a standstill of the fixed wing drone with respect to a vertical direction at the takeoff and landing device,

lowering of the fixed wing drone caused by gravitational force into a rest position on the takeoff and landing device, wherein a structure element of the fixed wing drone and a counter structure element of a holding element of the takeoff and landing device interlock.

### FURTHER ASPECTS OF THE INVENTION

In one embodiment, the object holding device is arranged between the drive units.

In one embodiment, the clamping device is motorized and in other embodiments it can be moved into the open state (for example, manually) under pre-tension and provides a clamping mechanism, triggered by a landing drone. The clamping device can be designed to clamp the landed drone, in particular wherein the clamping device comprises at least one clamping element which clamps the wings of the drone with the holding element in the closed state.

The holding element is in particular shaped so that the drone self-stabilizes its location thereon by means of the displaceable engagement elements, in particular self-centers.

The takeoff and landing device can also comprise a light guiding system, which comprises at least one lighting element or one reflector.

The lighting element and/or the reflector are preferably provided on the guide element, possibly the takeoff guide element, and also the holding element.

The conveyor system can be designed to convey an object accommodated by the object holding device into the object catching device when the drone touches the takeoff and landing device.

Said mechanical fixing mechanism can comprise, for example, a hook, which engages in an eye optionally comprised by the drone.

In one embodiment, the takeoff and landing device comprises a repelling device, which is designed for a takeoff of the drone to deflect the drone using a repulsion momentum from the vertical construction, in particular wherein the repelling device comprises a pole-reversible electromagnet, which is designed so it can interact with a ferromagnetic counterpart comprised by the drone, and/or wherein the repelling device provides a mechanical repelling mechanism.

When reference is made to “above”, this is thus in relation to an alignment of the drone during a conventional flight. When reference is made to “behind”, “rear”, “in front”, or “forward”, this is thus additionally in relation to a flight direction of the drone during a conventional flight. During a conventional flight, the wing is aligned so that its profile generates lift.

### BRIEF DESCRIPTION OF THE DRAWINGS

Further advantages of the present invention are apparent from the detailed description and the drawings.

FIG. 1 shows an embodiment of a drone according to the invention;

FIG. 2 shows an embodiment of a takeoff and landing device according to the invention from the front;

FIG. 3 shows the takeoff and landing device according to FIG. 2 from the rear;

FIG. 4 shows the takeoff and landing device according to FIG. 2 from the front having a drone resting thereon according to FIG. 1;

FIG. 5 shows the arrangement from FIG. 4 in a side view and the ejection of an object transported using the drone;

FIG. 6 shows a landing approach of a drone according to FIG. 1 to a takeoff and landing device according to FIG. 2.

### DETAILED DESCRIPTION OF THE DRAWINGS

According to the invention, a landing approach of a drone to a takeoff and landing device may be carried out nearly silently. This also enables deliveries at resting times, for example, at night. An optional light guiding system can assist landing at night. Moreover, the target group for a drone package delivery is increased by providing a takeoff and landing station. Thus, for example, a balcony, a window, and/or the accessibility of a house façade are sufficient, in contrast to other concepts which require open areas or flat roofs. In addition, third parties do not have access to the package or the drone and therefore reliable delivery can be guaranteed.

The drone according to the invention can cover very long distances, since it, like other planar models as well, enables very efficient cruising flight. The drone can be secured on the wall at the customer and charged, because of which a costly logistics center for regular storage of the drones is not absolutely necessary. These “parking spaces” at the customers can also be considered to be a decentralized network. The drone can thus also fly directly to another customer on demand, where a package has to be picked up, for example.

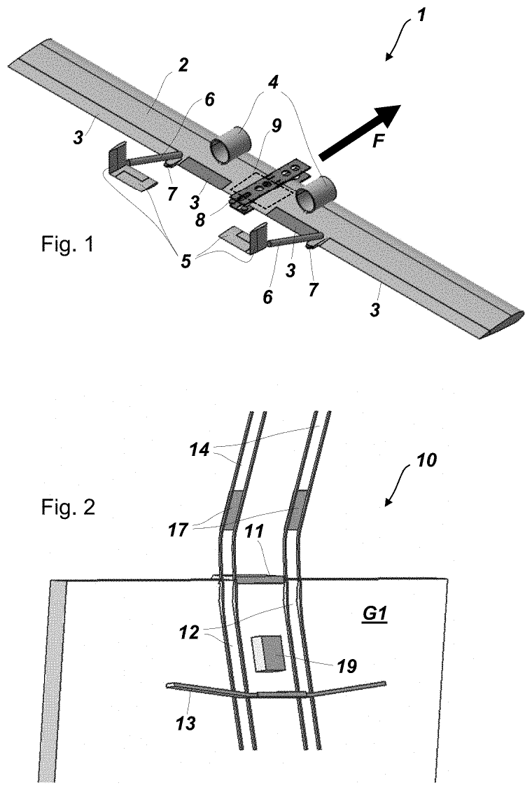

FIG. 1 shows an exemplary embodiment of a fixed wing drone 1 (referred to hereinafter as “drone”) according to the invention having wing 2, wing control surfaces 3, drive units 4, and two tail assemblies 5, which are each connected via a carrier element 6 to the wing. The carrier element 6 positions the tail assemblies 5 behind and above the wing 2, wherein “behind” relates to a flight direction F and “above” relates to the alignment during the flight (i.e., FIG. 1 shows the drone from a bird's-eye perspective from above). As shown in the figure, the wing control surfaces 3 comprise the ailerons and the flaps. The tail assemblies 5 also comprise the elevators and the rudders.

The drive units 4 comprise impellers or enclosed propellers here and are electrically operated by means of a battery. Although they are shown on the wing 2, the drive units 4 can also be integrated into the wing. Impellers are a further noise-reducing improvement over propellers.

The drone has two structure elements 7, which are accessible from the rear, at the rear edge of the wing 2. The structure elements 7 are shown as rotatably mounted small wheels or disks. Furthermore, the drone 1 has an object holding device 8, on which packages or other shipments can be fastened for transport.

In other embodiments, the at least one structure element can be shaped differently, on the one hand, for example, as a tab, fork, hook, eye, sliding block, or groove, and, on the other hand, it can be arranged elsewhere, for example, above or below the wing or on the object holding device 8. A control unit is housed here by way of example in the onboard computer 9 of the drone in or on the wing 2. The drone can be manually remote-controlled and/or autonomously operated via the control unit. A receiving unit, which is also contained in the onboard computer 9, can receive control signals, for example, via radio technologies such as wireless LAN or the mobile network. The onboard computer 9 also comprises a battery for supplying the receiving unit, the control unit, and the drive units 4 with current and/or for driving the wing control surfaces 3 and tail assemblies 5.

The object holding device 8 can optionally comprise a conveyor system, via which a package can be conveyed in front of or behind the wing, where it is then ejected and/or falls down.

The drone 1 can furthermore comprise a camera system, which can interact at least with the control unit. At least one camera of the camera system records the surroundings of the drone and the camera system is configured to analyze the recorded surroundings, wherein in particular object recognition algorithms are used. The camera system can control the drone 1 based at least on these algorithms. The at least one camera is preferably arranged on the front edge or the lower side of the wing.

The drone 1 preferably also comprises a navigation unit, in particular in the onboard computer 9. The navigation unit comprises in this case a Global Navigation Satellite System (GNSS) receiver, an inertial measuring unit (IMU), and/or other instruments for determining position and orientation of the drone 1 in space.

One embodiment of the takeoff and landing device 10 according to the invention is shown in FIG. 2. It is designed so that it can be installed in front of a window, in front of a façade or a railing outer side G1 of a balcony. The takeoff and landing device can also be attached to an auxiliary framework, which is installed on a roof or a fence. In brief, the takeoff and landing device 10 comprises an attachment device 11, via which the takeoff and landing device 10 can be attached to a structure.

The takeoff and landing device 10 furthermore comprises two guide elements 12, which each comprise two rods here, but also can be embodied differently, for example, as sheets or wide rods. The guide elements 12 are freely accessible (i.e., they point away from the structure G1) and are arranged so that they extend down the vertical structure starting from the attachment device 11, and do so at an angle of 1°, in particular 12° or 6°, but up to 89°. A holding element 13 is attached transversely to the guide elements 12 and thus extends horizontally. The holding element 13 has a counter structure element, which is accessible from above. The counter structure element is adapted in particular to the structure element 7 of the drone. The counter structure element is thus a grooved aperture along the holding element 13 here, in which the two small wheels 7 of the drone from FIG. 1 can hook or engage and in particular can also roll along therein.

The takeoff and landing device 10 shown here additionally also comprises takeoff guide elements 14. In another embodiment, these takeoff guide elements 14 are installed rigidly on the attachment device 11 and/or the guide elements 12 in the position shown. As an optional extra function, however, the takeoff guide elements 14 also function as a clamping device, which is pivotably fastened on the attachment device 11 and/or on the guide elements 12. In particular, the clamping device (=takeoff guide element) 14 has a snap mechanism or a motorization for clamping a drone in a closed state (the open state is shown here). Alternatively, however, the clamping device can also be moved manually into the open and the closed state and locked accordingly therein.

As an optional extra, the takeoff and landing device also comprises a docking station 19. It provides charging current and/or a unidirectional or bidirectional data traffic. An interface of the docking station is adapted to a corresponding—also optional—interface of the drone 1, i.e., the interface can be plug-based and/or wired or wireless (inductive charging, NFC, Bluetooth, Wi-Fi, etc.).

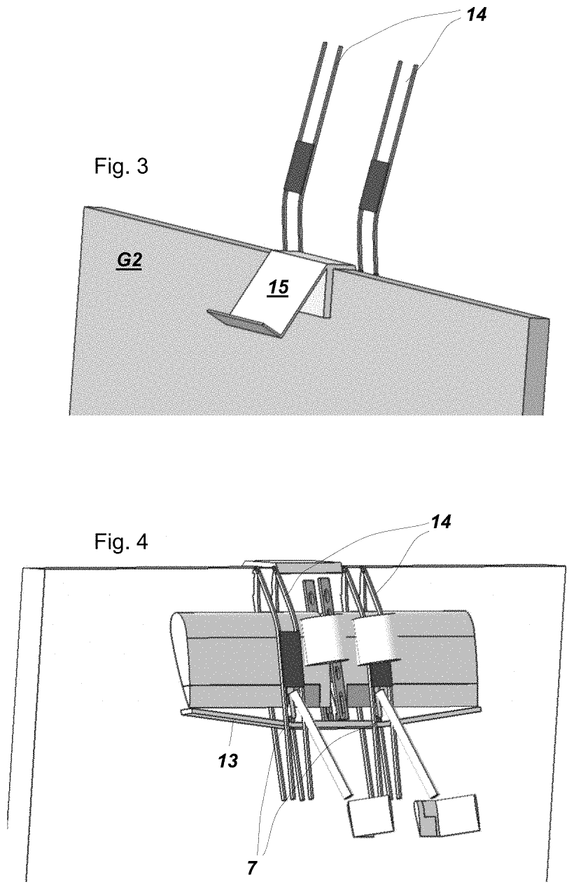

FIG. 3 shows the rear side of the exemplary attachment device 11, which also comprises an optional object catching device 15 here, which can interact with the optional conveyor system of the drone 1, i.e., the object catching device 15 is designed so that it can catch a package ejected by the conveyor system. In this case, the object catching device 15 is a catch basket; however, it can also be embodied as a catch net or catch trough. In the example shown, the object catching device 15 is located on a railing inner side G2 of the railing also shown in FIG. 2. In other embodiments, the object catching device can also be provided at other locations, however, for example, above the attachment device 11 or below the guide elements 12.

FIG. 4 shows how the drone 1 from FIG. 1 rests on the takeoff and landing device 10. Due to the inclination of the guide elements between 1° and 89°, in particular 12° or 6°, in relation to the vertical, the drone 1 resting in the takeoff and landing device 10 does not tip to the rear. The center of gravity of the drone 1 is also correspondingly configured far below for this purpose, wherein “below” also relates here to an alignment during the conventional flight.

In other embodiments, the center of gravity location does not necessarily have to be such that tipping out of the drone 1 in the parking position is prevented solely by the construction, because the takeoff and landing device 10 can additionally, as explained above, comprise a clamping device 14 (as shown in the closed state in FIG. 4) and/or an attraction unit, which comprises, for example, an electromagnet or a permanent magnet and is designed to provide a magnetic attraction force for attracting the drone 1. For this purpose, the drone 1 then has a corresponding ferromagnetic counterpart (in particular also an (electro-)magnet) at a defined point in relation to the attraction unit. The attraction unit can be provided additionally or alternatively to the takeoff guide element 14 or additionally or alternatively to the clamping device 14.

The drone 1 rests with its structure elements 7 on the holding element 13. In this case, the structure elements formed as small wheels engage in a counter structure element (in this case: embodied as a groove) incorporated on the upper side of the holding element 13. In other embodiments, the configuration is the other way around: the counter structure element on the holding element 13 has multiple small wheels arranged in series or simply only one smooth runner, and the structure elements 7 on the drone 1 are formed as a fork or bridge, wherein the two elements again interlock. In still other embodiments, the holding element 13 can be a type of “pocket” having opening accessible from above, wherein the structure element 7 of the drone is formed as a type of “tongue”, which is insertable easily and with spatial tolerance into the pocket.

As an optional additional expansion, the small wheels (=structure element) 7 can roll and/or slide along the rail (=holding element) 13 bent upward in a taper, so that the drone can thus center itself.

If the drone has safely landed, as shown in FIG. 6 in a side view, the object holding device 8 can contain an optional conveyor system to eject an object O to be delivered upward, so that it can land (O′) in the object catching device 15.

FIG. 6 shows an exemplary landing approach, in which the drive units of the drone can be shut down to protect from noise. The takeoff and landing device 10 is installed on the balcony B. The trajectory of the drone (dashed line) shows that the drone temporarily sinks low enough that it is located below the takeoff and landing device 10. The drone is then controlled so that it rises again to finally abut or rest in a matching angle on the guide elements 12, wherein the drone then has almost no kinetic energy remaining and sinks down. The structure elements 7 then mesh with the counter structure element on the holding element.

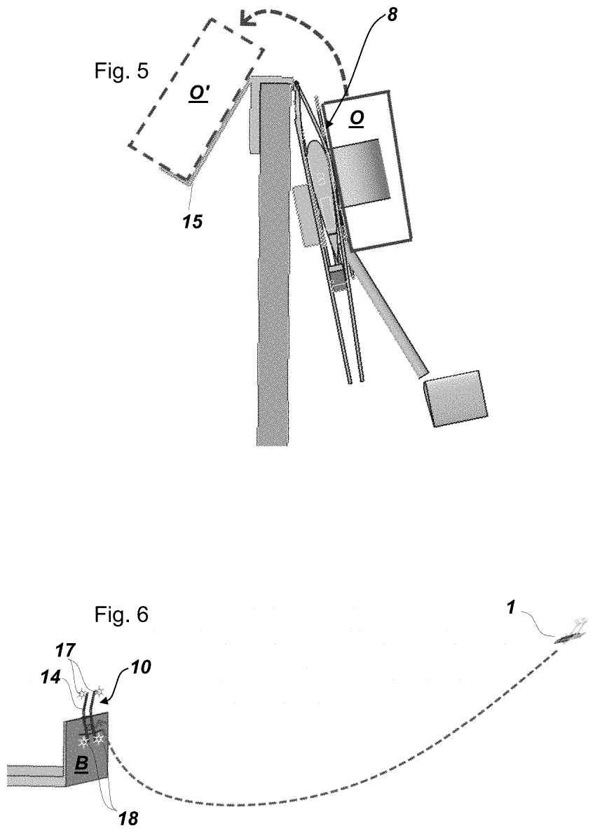

In consideration of many factors, for example, wind and weight of the cargo, the flight path for the landing is computed so that the momentum, i.e., in particular the kinetic energy in the vertical direction, drops precisely when the drone is almost above the position shown in FIGS. 4 and 5. An optional light guiding system can assist this; the drone, which then has a camera system, can thus recognize the pose of the takeoff and landing device 10 even more reliably, and in particular also at night. The light guiding system can comprise light-emitting diodes or reflectors (the drone can also comprise a corresponding light source for this purpose), which are shown with reference sign 17 in FIG. 2 and FIG. 6 and with reference sign 18 in FIG. 6.

Shortly before landing, the clamping device 14 is extended. In the extended or open state, a warning can be signaled via a display screen or a warning light toward the inner side of the balcony B or toward a window, which leads to the balcony, for example, having the words “please step back”. In the extended state, the light guiding system is also preferably active, so that the drone finds the landing framework at night as in the day and thus the special landing method can be applied fully autonomously even better. During landing of the drone, the takeoff guide element 14 protects persons possibly standing on the balcony and simultaneously expands the landing surface for the drone. Accordingly, the first contact of the drone can also take place at the very top on the takeoff guide element 14, which is embodied as the clamping device here, and it then slides downward until the drone stands with the small wheels 7 on the rail 13 (=holding element).

Due to the inclination on both sides of the rail 13, the drone centers itself in the middle. A small notch at the inflection of the rail can optionally cause the drone to lock in this position. As soon as the drone is locked, the clamping device 14 closes and clamps the drone between itself and the guide elements 12. The drone is thus secured from windstorms or other influences and can no longer be moved.

When the drone 1 is finally locked, it can dock using data and/or power cables or wirelessly on the optional docking station 19 (see FIG. 2). If the object catching device 15 should still be full or the mechanism from FIG. 5 is not executable for other reasons, the customer can be informed that the package is to be removed.

The takeoff and landing device is also designed in the version shown for a preferred takeoff procedure. In the open position of the takeoff guide elements 14, they can be used as a quasi-ramp by the drone, whereby a safer takeoff from the balcony or from the wall is ensured. In another variant, this repulsion can also take place due to a magnetic force, wherein a repelling device is provided on the takeoff and landing device for this purpose. Such a repelling device can also function mechanically, however, specifically, for example, in that a pre-tensioned repelling element repels the drone at a specific point in time. In a further embodiment, however, the drone can also “repel” entirely on its own, in that the wing control surfaces and the tail assemblies are simply activated accordingly to give the drone the required lift.

The drone preferably has a completely flat lower side. Landing of the drone with pinpoint accuracy is not necessary—it can land on the entire surface between the guide elements 12 (and possibly takeoff guide elements 14) and the holding element 13. No matter where the drone lands on the surface, it first slides, at least due to gravity, downward until the small wheels (=structure element 7) arrive at the holding element 13 designed as a rail and engage therein in the counter structure element. Switched-on electrical thrusters 4 (=drive units) can optionally slow the sliding down or correct a landing position deviating from the intention. Due to the inclination of the rail (=holding element) 13 in relation to the vertical, the inflection in the rail (outer arms), and the flat lower side of the drone, the drone can roll laterally on the rail and center itself in the example shown. If this should not have functioned, however, for example, because the wind influences have been very large, it is possible to help during the centering of the drone via the electrical thrusters (=drive unit) 4 and the control surfaces.

In one preferred embodiment, the drone is designed having protected (encased) electrical thrusters 4, so that the rotating parts are not freestanding and accordingly the risk of injury is reduced in every situation. Moreover, the noise emission is significantly reduced. The thrusters 4 on the upper side of the drone additionally permit a higher lift in cruising flight and reduce the noise emission downward. Other attachment locations are possible, however.

In cruising flight, the object holding device 8, which can be designed as a conveyor system, can be used to displace the package O to the front or to the rear and to set the center of gravity of the complete configuration ideally.

The drone 1 is preferably equipped with multiple small cameras (as part of the camera system) to recognize and avoid other flying objects, to be able to fly the landing precisely, and to check before the takeoff whether obstacles are present.

The drone 1 flies in hover flight at a steep angle toward the landing station, wherein the thrusters (=drive units) 4 are switched off. The camera system recognizes via the switched-on light guiding system in the video image where the takeoff and landing device 10 is positioned. The drone can measure the distance to the landing station in dependence on the size of the takeoff and landing framework in the video image. The location of the drone can be ascertained internally via the IMU and the horizontal and vertical angle in relation to the landing station can be determined accordingly.

From a certain distance and angle to the landing framework, the flare-out is initiated, which is set so that the drone can set down at the right angle and the right height on the takeoff and landing device 10. In this case, the energy of the hover flight is sufficient without having to switch on the drive units once again. In this case, the drone lands silently. Many factors are taken into consideration here so that the landing takes place silently, for example, package weight, package size, wind speed, wind direction, temperature, height, etc.

Although the invention was explained based on its preferred embodiment(s), many further modifications and variations can nonetheless be performed without going beyond the scope of the present invention. It is therefore provided that the appended patent claims cover modifications and variations which are included in the actual scope of the invention.

1. A fixed wing drone (1) for delivering objects, comprising:
a wing (2) having an airfoil and having wing control surfaces (3);
at least two drive units (4);
at least one tail assembly (5) having tail control surfaces, wherein the tail assembly is arranged above the wing and behind the wing by a carrier element (6) connected to the wing;
at least one structure element (7) protruding towards the rear and accessible from the rear;
an object holding device (8), which is arranged above the wing and is designed to accommodate an object;
a control unit, which is designed to control the fixed wing drone (1), in particular the wing control surfaces, the tail control surfaces, and the drive units, based on control signals; and
a receiving unit, which is designed to receive control signals.

2. The fixed wing drone (1) according to claim 1, wherein the drive units comprise enclosed propellers, in particular impellers.

3. The fixed wing drone (1) according to claim 1, wherein each of the engagement elements is a sliding element or a rotatably mounted disk.

4. The fixed wing drone (1) according to claim 1, wherein the object holding device comprises a conveyor system, which is designed to convey an object accommodated by the object holding device to the front or rear, in particular to convey the object in front of or behind the wing and eject it in front of or behind the wing or to change the center of gravity during a flight.

5. The fixed wing drone (1) according to claim 1, furthermore comprising a camera system, which is designed for object recognition, wherein the control unit is furthermore designed to control the fixed wing drone (1) based on the object recognition.

6. A takeoff and landing device for a fixed wing drone (1) comprising:
an attachment device (11), which is designed to attach the takeoff and landing device to a structure, in particular to a vertical side of a structure;
at least one guide element (12), which is connected to the attachment device and is designed so that, starting from the attachment device, it leads away from the structure downward and at an angle between 1° and 89°, in particular 12° in relation to the vertical; and
a holding element (13), which is attached transversely to the guide elements and comprises at least one counter structure element accessible from above.

7. The takeoff and landing device according to claim 6, furthermore comprising:
at least one takeoff guide element (14), which is connected to the attachment device and leads, starting from the attachment device, at an angle between 1° and 89° in relation to the vertical upward and away from the structure.

8. The takeoff and landing device according to claim 7, furthermore comprising
an object catching device, in particular wherein the attachment device comprises the object catching device.

9. The takeoff and landing device according to claim 8, furthermore comprising
a fixing device, in particular comprising an electromagnet designed to provide an attraction force for attracting the fixed wing drone or comprising a mechanical fixing mechanism.

10. A fixed wing drone (1) for delivering objects, comprising:
a wing (2) having an airfoil and having wing control surfaces (3);
at least two drive units (4);
at least one tail assembly (5) having tail control surfaces, wherein the tail assembly is arranged above the wing and behind the wing by a carrier element (6) connected to the wing;
at least one structure element (7) protruding towards the rear and accessible from the rear;
an object holding device (8), which is arranged above the wing and is designed to accommodate an object;
a control unit, which is designed to control the fixed wing drone (1), in particular the wing control surfaces, the tail control surfaces, and the drive units, based on control signals;
a receiving unit, which is designed to receive control signals;
a takeoff and landing device for the fixed wing drone (1) having:
an attachment device (11), which is designed to attach the takeoff and landing device to a structure, in particular to a vertical side of a structure;
at least one guide element (12), which is connected to the attachment device and is designed so that, starting from the attachment device, it leads away from the structure downward and at an angle between 1° and 89°, in particular 12° in relation to the vertical; and
a holding element (13), which is attached transversely to the guide elements and comprises at least one counter structure element accessible from above.

11. The fixed wing drone according to claim 10, wherein the structure element of the fixed wing drone (1) and the counter structure element are designed to be interlockable, and the fixed wing drone (1) is displaceable along the holding element by means of the interlocking structure element and counter structure element.

12. The fixed wing drone (1) according to claim 10 further comprising at least one takeoff guide element (14), which is connected to the attachment device and leads, starting from the attachment device, at an angle between 1° and 89° in relation to the vertical upward and away from the structure, wherein the takeoff guide element is designed as a clamping device, which is pivotable between an open state and a closed state, wherein the clamping device, in the open state, leads upward and away from the structure starting from the attachment device at an angle between 1° and 89° in relation to the vertical and can abut the holding element or the guide element in the closed state, wherein the clamping device is motorized or can be moved into the open state under pre-tension and provides a clamping mechanism triggered by a landing fixed wing drone (1), wherein the clamping device is designed to clamp the landed fixed wing drone (1), in particular on the wing.

13. The fixed wing drone (1) according to claim 10, wherein the takeoff and landing device comprises a light guiding system, which comprises at least one lighting element or a reflector, wherein the camera system is designed to recognize the lighting element or the reflector, wherein the control unit is designed to determine a pose of the takeoff and landing device with the aid of the recognized lighting element or reflector and to generate control signals with the aid of the determined pose.

14. The fixed wing drone of claim 13, wherein the fixed wing drone (1) furthermore comprises an interface, which is designed to receive electrical energy and/or data, and wherein the takeoff and landing device comprises a counter interface, which is designed to supply the fixed wing drone (1) with electrical energy and/or data.

15. An approach method comprising the steps off:
loading a fixed wing drone (1) with an object;
controlling the fixed wing drone (1) based on received control signals in the direction of a delivery location until a defined remaining distance remains to the delivery location;
after reaching the remaining distance, deactivating the drive units;
activating a light guiding system of a takeoff and landing device, which is attached to a structure;
recognizing the lighting element or the reflector using the camera system;
with the aid of the recognized lighting element or reflector, determining a pose of the takeoff and landing device using the control unit;
with the aid of the determined pose, generating control signals using the control unit;
controlling only the wing control surfaces and the tail control surfaces of the fixed wing drone (1), which is in glide flight, based on the generated control signals;
carrying out a landing approach which causes the fixed wing drone (1) to sink below the takeoff and landing device in the meantime and then rise again in a parabola to the takeoff and landing device;
achieving a standstill of the fixed wing drone (1) with respect to a vertical direction at the takeoff and landing device; and
lowering of the fixed wing drone (1) caused by gravitational force into a rest position on the takeoff and landing device, wherein a structure element of the fixed wing drone (1) and a counter structure element of a holding element of the takeoff and landing device interlock.
